(19) United States
(12) Patent Application Publication
(10) Pub. No.: US 2005/0117537 A1
(43) Pub. Date: Jun. 2, 2005

(54) Wireless communication system, wireless base station accommodating apparatus, and data packet transfer method

(75) Inventor: Toshiya Okabe, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/987,852

(22) Filed: Nov. 12, 2004

(30) Foreign Application Priority Data
Nov. 12, 2003 (JP) 2003-381892

(51) Int. Cl. H04Q 7/00

(52) U.S. Cl. 370/328

(57) ABSTRACT

A wireless communication system has a packet switch, a position management table, and a position detector. Based on the fact that a position registration packet including the MAC address of a mobile terminal is received from a certain port, the position detector recognizes that the mobile terminal is present in the service area of a wireless base station connected to the port. Then, the position detector registers the MAC address of the mobile terminal and the port number of the port in the position management table 12. When the packet switch receives a data packet, the packet switch extracts the MAC address of a destination from the data packet, and searches the position management table based on the extracted MAC address. If a port number is hit in the searching of the position management table, then the packet switch recognizes the hit port number as an output destination, and transfers the data packet to the port represented by the port number.

### BACKGROUND OF THE INVENTION

1. Field of the Invention

The present invention relates to a wireless communication system, a wireless base station accommodating apparatus, and a data packet transfer method, and more particularly to a high-speed wireless data communication system, a wireless base station accommodating apparatus, and a data packet transfer method for license-free high-speed wireless data communications, typically represented by a wireless LAN (Local Area Network).

2. Description of the Related Art

In recent years, license-free high-speed wireless data communication apparatus, typically represented by a wireless LAN, are in widespread use in homes and small offices. A wireless LAN system allows a plurality of wireless base stations to perform data communications with mobile terminals that are located in their respective communication areas through wireless circuits (see, for example, Japanese laid-open patent publication No. 2000-224645).

Various standards for wireless LANs depending on the frequencies and modulation processes used for wireless communications are established by IEEE (Institute of Electrical and Electronics Engineers). For example, these standards include IEEE 802.11a, IEEE 802.11b, IEEE 802.11g, etc.

The wireless LANs are finding a growing range of applications including conventional LAN applications, fixed wireless access (FWA) services provided by telecommunications carriers, and nomadic wireless access (NWA) services for mobile users.

With regard to conventional high-speed wireless data communication systems, it has been considered to provide services in a wider range. For providing services in a wider range, it is important to keep low the facility cost and the management cost for a larger number of mobile terminals and wireless base stations.

The conventional high-speed wireless data communication systems have various functions including a function to detect the movement of a mobile terminal, a function to identify the position of a mobile terminal, and a function to manage the position of a mobile terminal. These functions are provided in each of the mobile terminals or the wireless base stations. If wireless communication services are to be developed in a wide area, then since those functions need to be provided in each of the mobile terminals or the wireless base stations, a problem arises in that the facility cost and the management cost of the entire network tend to become high.

### SUMMARY OF THE INVENTION

It is an object of the present invention to provide a wireless communication system, a wireless base station accommodating apparatus, and a data packet transfer method, which make it possible to employ a simple system arrangement and reduce facility and management costs.

To achieve the above object, there is provided in accordance with the present invention a wireless communication system comprising a plurality of wireless base stations for performing wireless data communications with mobile terminals which are accommodated respectively thereby, and a wireless base station accommodating apparatus for accommodating the wireless base stations, the wireless base station accommodating apparatus having detecting means for detecting positions of the mobile terminals, and a position management table for registering therein identification information of the mobile terminals detected by the detecting means and identification information of the wireless base stations which accommodate the mobile terminals.

To achieve the above object, there is also provided in accordance with the present invention a method of transferring data packets to mobile terminals in a wireless communication system including a plurality of wireless base stations for performing wireless data communications with mobile terminals which are accommodated respectively thereby, and a wireless base station accommodating apparatus for accommodating the wireless base stations, comprising the steps, performed by the wireless base station accommodating apparatus, of detecting positions of the mobile terminals, and registering therein identification information of the mobile terminals which are detected and identification information of the wireless base stations which accommodate the mobile terminals.

The present invention resides in that a communication network based on a wireless communication process, typically represented by a wireless LAN, detects the positions of mobile terminals and transfers data packets with a simple arrangement.

According to the present invention, the wireless base station accommodating apparatus which accommodates the wireless base stations has the detecting means for detecting positions of the mobile terminals, and the position management table for registering therein identification information of the mobile terminals detected by the detecting means and identification information (e.g., the port numbers of ports to which the wireless base stations are connected, IDs inherent in the wireless base stations, or the like) of the wireless base stations which accommodate the mobile terminals. With this arrangement, since the mobile terminals and the wireless base stations do not need to have a position management function therein, the system arrangement is simple, and facility and management costs are reduced.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a wireless communication system according to an embodiment of the present invention;

FIG. 2 is a sequence chart showing operation of the wireless communication system according to the embodiment of the present invention;

FIG. 3 is a block diagram of a wireless communication system according to another embodiment of the present invention; and

FIG. 4 is a sequence chart showing operation of the wireless communication system according to the other embodiment of the present invention.

### DESCRIPTION OF THE PREFERRED EMBODIMENTS

Embodiments of the present invention will be described below with reference to the accompanying drawings.

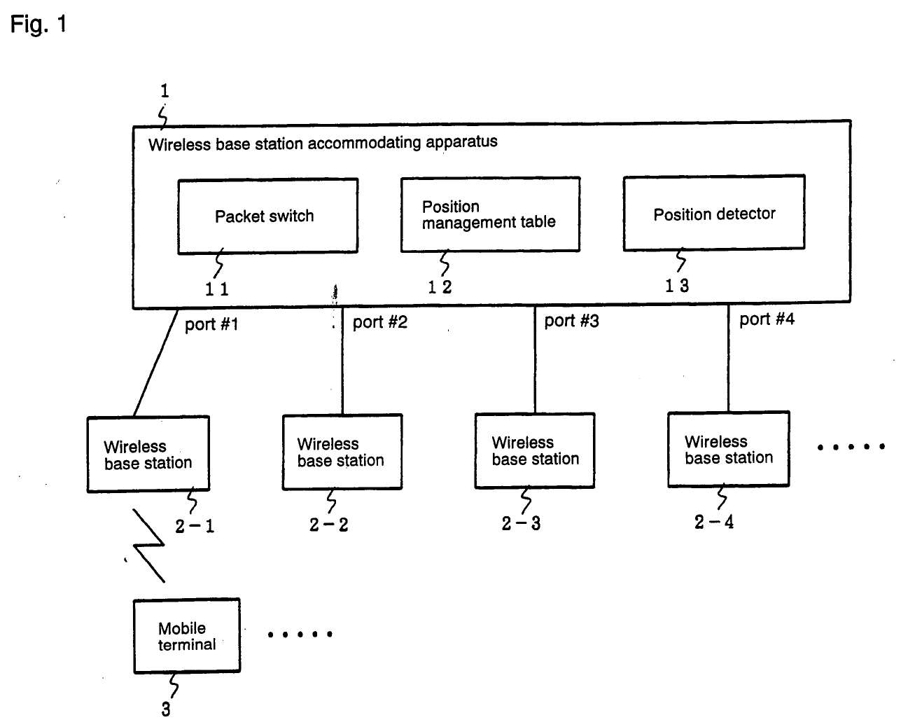

FIG. 1 shows in block form a wireless communication system according to an embodiment of the present invention. As shown in FIG. 1, the wireless communication system comprises wireless base station accommodating apparatus 1, a plurality of wireless base stations 2-i (i=1, 2, 3, 4, . . . ), and a plurality of mobile terminals 3.

Mobile terminals 3 are communication terminals such as PCs (Personal Computers), PDAs (Personal Digital Assistants), or the like, and have one or more wireless interfaces based on standards typically represented by IEEE (Institute of Electrical and Electronics Engineers) 802.11.

Wireless base stations 2-i are base stations having a wireless interface based on standards typically represented by IEEE 802.11. Wireless base stations 2-i are accommodated by wireless base station accommodating apparatus 1 through ports #i. Wireless base station accommodating apparatus 1 has packet switch 11 for transferring data packets addressed to mobile terminal 3 to appropriate wireless base station 2-i, and position management table 12 and position detector 13 for managing the positions of mobile terminals 3.

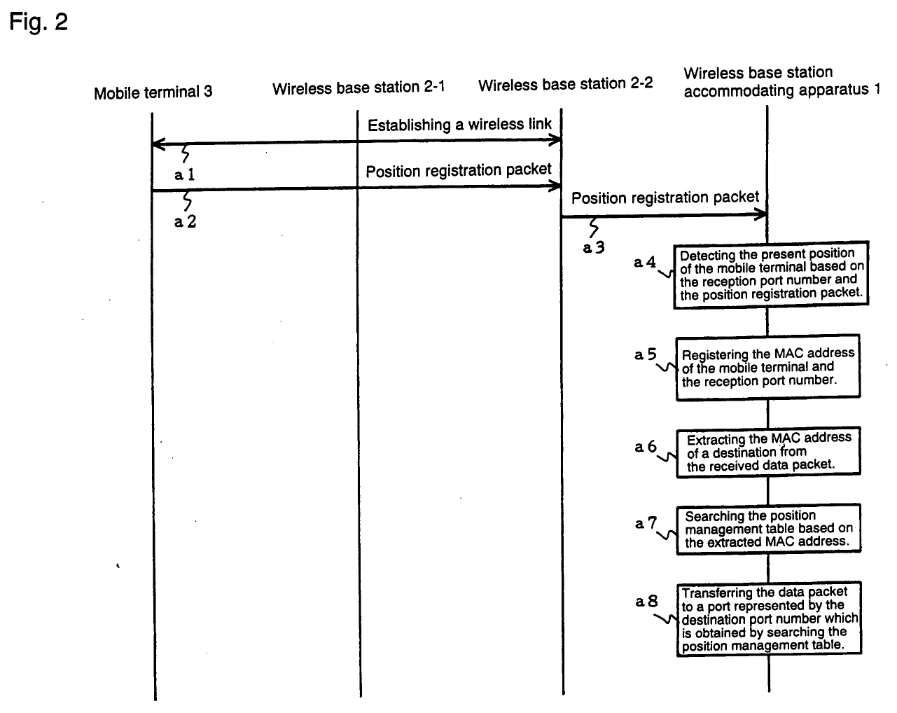

FIG. 2 is a sequence chart showing operation of the wireless communication system according to the embodiment of the present invention. A specific operation of the wireless communication system at the time mobile terminal 3 moves from wireless base station 2-1 to wireless base station 2-2 will be described below with reference to FIGS. 1 and 2.

When mobile terminal 3 moves from the service area of wireless base station 2-1 to the service area of wireless base station 2-2, mobile terminal 3 establishes a wireless link to wireless base station 2-2 (a1 in FIG. 2). When the wireless link is established between mobile terminal 3 and wireless base station 2-2, mobile terminal 3 sends a position registration packet to wireless base station 2-2 (a2 in FIG. 2).

The position registration packet includes the MAC (Media Access Control) address of mobile terminal 3. The position registration packet has a header with information written therein indicating that the position registration packet is a control packet for positional registration. For example, the position registration packet uses the field of the Ethernet(R) frame type to indicate that the position registration packet is a control packet.

When wireless base station 2-2 receives the position registration packet from mobile terminal 3, wireless base station 2-2 transfers the received position registration packet to wireless base station accommodating apparatus 1 (a3 in FIG. 2). Wireless base station accommodating apparatus 1 receives the position registration packet transferred from wireless base station 2-2 through port #2 to which wireless base station 2-2 is connected.

Wireless base station accommodating apparatus 1 checks the field of the Ethernet(R) frame type of the received position registration packet to recognize that the received packet is a position registration packet. If the received packet is a position registration packet, then wireless base station accommodating apparatus 1 sends information indicating that the received packet is a position registration packet, together with the reception port number, to position detector 13. Since wireless base station accommodating apparatus 1 has received the position registration packet transferred from wireless base station 2-2 through port #2, the reception port number is “port #2”.

Based on the fact that the position registration packet including the MAC address of mobile terminal 3 is received from port #2, position detector 13 recognizes that mobile terminal 3 is present in the service area of wireless base station 2-2 under port #2 (a4 in FIG. 2). Then, position detector 13 registers the MAC address of mobile terminal 3 and the reception port number “port #2” in position management table 12 (a5 in FIG. 2). Position management table 12 stores the MAC addresses of mobile terminals and reception port numbers in association with each other. By referring to position management table 12, therefore, it is possible to acquire a port number to which there is connected a wireless base station with a mobile terminal positioned in its service area, from the MAC address of the mobile terminal.

When packet switch 11 receives a data packet, packet switch 11 extracts the MAC address of a destination from the received data packet (a6 in FIG. 2), and searches position management table 12 based on the extracted MAC address (a7 in FIG. 2). If there is a MAC address in agreement with the extracted MAC address in position management table 12, then packet switch 11 recognizes that the port number registered in position management table 12 in association with the MAC address is a destination, and transfers the data packet to a port represented by the destination port number (a8 in FIG. 2).

In the wireless communication system according to the present embodiment, as described above, wireless base station accommodating apparatus 1 that accommodates wireless base stations 2-i through ports #i has packet switch 11 for transferring data packets addressed to mobile terminal 3 to appropriate wireless base station 2-i, and position management table 12 and position detector 13 for managing the positions of mobile terminals 3. With this arrangement, mobile terminals 3 and wireless base stations 2-i are not required to have a function to manage the positions of the mobile terminals. Therefore, the wireless communication system may be of a simple system arrangement and is able to reduce facility and management costs.

In the wireless communication system according to the present embodiment, if mobile terminals 3 have two or more wireless interfaces and destinations to which mobile terminals 3 will be moved can be predicted, then wireless base station accommodating apparatus 1 may be arranged to transfer a data packet to a port to which there is connected a wireless base station corresponding to the present position of mobile terminal 3 and also simultaneously to a port to which there is connected a wireless base station corresponding to a predictable destination to which mobile terminal 3 will be moved. For example, if wireless base stations 2-i are positioned along a straight road, a railway track, or the like, then it is possible to predict wireless base station 2-i as a destination to which a mobile terminal will be moved next. With this arrangement, packets are prevented from being lost even when mobile terminals 3 move at a high speed.

A specific operation of the wireless communication system for simultaneously transferring a data packet to a wireless base station corresponding to the present position of a mobile terminal and a wireless base station corresponding to a predictable destination to which mobile terminal will be moved, will be described below.

If mobile terminal 3 can be predicted to move from wireless base station 2-1 to wireless base station 2-2 shown in FIG. 1, then position detector 13 registers two transfer destinations (port #1 and port #2) when updating position management table 12. Position management table 12 stores the MAC address of mobile terminal 3 and “port #1” in association with each other and also stores the MAC address of mobile terminal 3 and “port #2” in association with each other.

When packet switch 11 receives a data packet, packet switch 11 extracts the MAC address of a destination from the received data packet, and searches position management table 12 based on the extracted MAC address. If a plurality of entries are hit in the searching of position management table 12, then packet switch 11 makes as many copies of the data packet as the number of the entries, and simultaneously transfers the copied data packets to ports corresponding to the entries. For example, if the MAC address of a destination is the MAC address of mobile terminal 3, then two entries with respect to “port #1” and “port #2” are hit in the searching of position management table 12, and the copied data packets are simultaneously transferred to “port #1” and “port #2”.

In the wireless communication system according to the present embodiment, authentication information may be included in the position registration packet. In this case, wireless base station accommodating apparatus 1 may have an authenticating means (not shown), and the position of a mobile terminal may be registered using only a position registration packet which has been confirmed as being proper by the authenticating means, and a data packet may be transferred. With this arrangement, it is possible to prevent unauthorized access from a third party using an improper position registration packet.

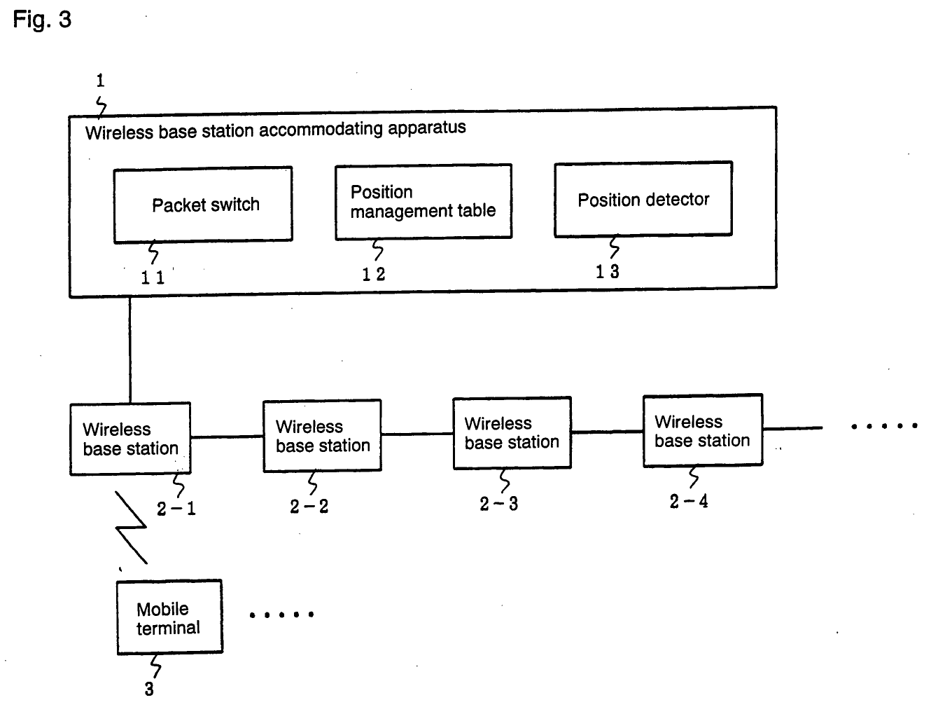

FIG. 3 shows in block form a wireless communication system according to another embodiment of the present invention. The wireless communication system shown in FIG. 3 is similar to the wireless communication system shown in FIG. 1 except that wireless base stations 2-i are connected in cascade. Those parts of the wireless communication system shown in FIG. 3 which are identical to those of the wireless communication system shown in FIG. 1 are denoted by identical reference characters.

As shown in FIG. 3, since wireless base stations 2-i are connected in cascade, the wireless communication system according to the present embodiment efficiently utilizes transmission paths and reduces the cost required to lay down transmission paths. Wireless base stations 2-i are given respective ID (identification information). For example, ID “1” is assigned to wireless base station 2-1, ID “2” to wireless base station 2-2, ID “3” to wireless base station 2-3, and ID “4” to wireless base station 2-4.

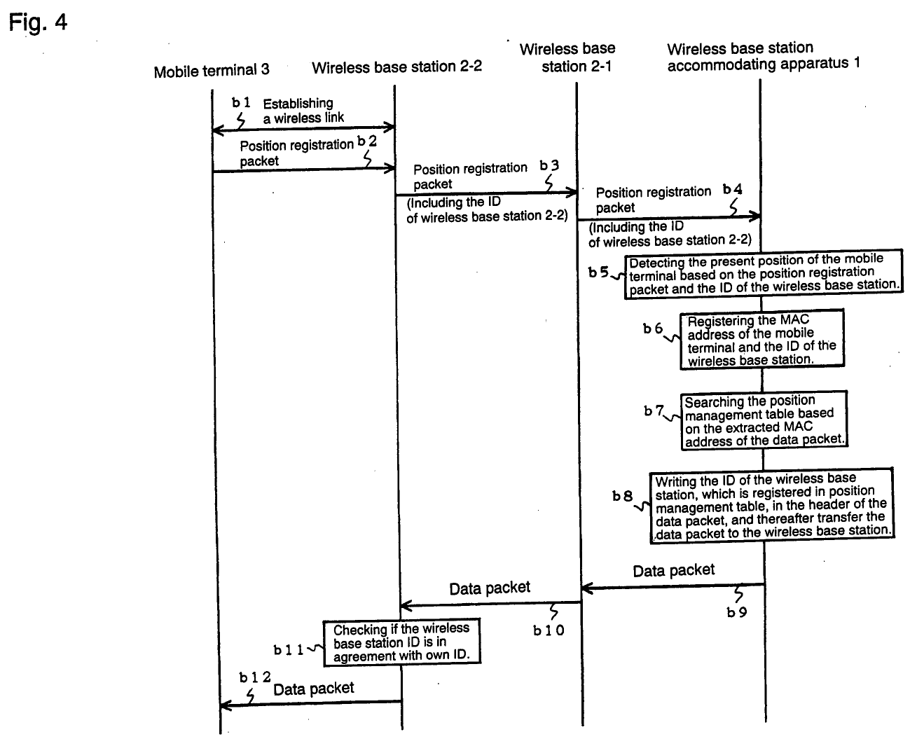

FIG. 4 is a sequence chart showing operation of the wireless communication system according to the other embodiment of the present invention. A specific operation of the wireless communication system at the time mobile terminal 3 moves from wireless base station 2-1 to wireless base station 2-2 will be described below with reference to FIGS. 3 and 4.

When mobile terminal 3 moves from the service area of wireless base station 2-1 to the service area of wireless base station 2-2, mobile terminal 3 establishes a wireless link to wireless base station 2-2 (b1 in FIG. 4). When the wireless link is established between mobile terminal 3 and wireless base station 2-2, mobile terminal 3 sends a position registration packet to wireless base station 2-2 (b2 in FIG. 4).

The position registration packet includes the MAC address of mobile terminal 3. The position registration packet has a header with information recorded therein indicating that the position registration packet is a control packet for positional registration. For example, the position registration packet uses the field of the Ethernet(R) frame type to indicate that the position registration packet is a control packet.

When wireless base station 2-2 receives the position registration packet from mobile terminal 3, wireless base station 2-2 transfers the received position registration packet to wireless base station accommodating apparatus 1 through wireless base station 2-1 cascaded to wireless base station 2-2 (b3, b4 in FIG. 4). When wireless base station 2-2 transfers the position registration packet, it writes the ID “2” indicating itself in the header of the position registration packet, indicating that the position registration packet has been transferred via wireless base station 2-2.

When wireless base station accommodating apparatus 1 receives the position registration packet, wireless base station accommodating apparatus 1 checks the field of the Ethernet(R) frame type of the received position registration packet and also the wireless base station ID written in the header. By checking the field of the Ethernet(R) frame type, wireless base station accommodating apparatus 1 can recognize that the received packet is a position registration packet. By checking the wireless base station ID, wireless base station accommodating apparatus 1 can recognize the location of mobile terminal 3. If the received packet is a position registration packet, then wireless base station accommodating apparatus 1 indicates that the received packet is a position registration packet, and sends the wireless base station ID written in the header, to position detector 13. Since wireless base station accommodating apparatus 1 has received the position registration packet transferred from wireless base station 2-2, the wireless base station ID written in the header is “2”.

Position detector 13 detects that the position registration packet including the MAC address of mobile terminal 3 is received from wireless base station 2-2, from the fact that the received packet is a position registration packet and the wireless base station ID is “2” (b5 in FIG. 4), and hence recognizes that mobile terminal 3 is present in the service area of wireless base station 2-2. Position detector 13 registers the MAC address of mobile terminal 3 and the ID “2” of wireless base station 2-2 in position management table 12 (b6 in FIG. 4). Position management table 12 stores the MAC addresses of mobile terminals and reception port numbers in association with each other. By referring to position management table 12, therefore, it is possible to acquire the ID of a wireless base station with a mobile terminal positioned in its service area, from the MAC address of the mobile terminal.

When packet switch 11 receives a data packet, packet switch 11 extracts the MAC address of a destination from the received data packet, and searches position management table 12 based on the extracted MAC address (b7 in FIG. 4). If there is a MAC address in agreement with the extracted MAC address in position management table 12 in the searching of position management table 12, then packet switch 11 writes the ID of the wireless base station that is registered in position management table 12 in association with the MAC address, in the header of the data packet, and thereafter transfers the data packet to cascaded wireless base station 2-1 (b8, b9 in FIG. 4).

When each wireless base station 2-i receives the data packet, it checks if the wireless base station ID written in the header of the received data packet is in agreement with the ID of its own or not. If the wireless base station ID written in the header of the received data packet is in agreement with the ID of its own, then wireless base station 2-i recognizes that the data packet is addressed thereto, and sends the data packet to the mobile terminal through the wireless links (b10 through b12 in FIG. 4). If the wireless base station ID written in the header of the received data packet is not in agreement with the ID of its own, then wireless base station 2-i transfers the data packet to a wireless base station located downstream thereof.

In the wireless communication system according to the present embodiment, as described above, wireless base station accommodating apparatus 1 that accommodates a plurality of wireless base stations 2-i connected in cascade has packet switch 11 for transferring data packets addressed to mobile terminal 3 to appropriate wireless base station 2-i, and position management table 12 and position detector 13 for managing the positions of mobile terminals 3. With this arrangement, mobile terminals 3 and wireless base stations 2-i are not required to have a function to manage the positions of the mobile terminals. Therefore, the wireless communication system may be of a simple system arrangement and is able to reduce facility and management costs.

While preferred embodiments of the present invention have been described using specific terms, such description is for illustrative purposes only, and it is to be understood that changes and variations may be made without departing from the spirit or scope of the following claims.

1. A wireless communication system comprising:
a plurality of wireless base stations for performing wireless data communications with mobile terminals which are accommodated respectively thereby; and
a wireless base station accommodating apparatus for accommodating said wireless base stations;
said wireless base station accommodating apparatus having detecting means for detecting positions of said mobile terminals, and a position management table for registering therein identification information of said mobile terminals detected by said detecting means and identification information of said wireless base stations which accommodate said mobile terminals.

2. A wireless communication system according to claim 1, wherein said detecting means detects positions of said mobile terminals from position registration packets sent from the mobile terminals.

3. A wireless communication system according to claim 1, wherein the identification information of said wireless base stations comprises numbers of ports through which said wireless base stations are connected to said wireless base station accommodating apparatus.

4. A wireless communication system according to claim 2, wherein said wireless base stations are connected in cascade, and the identification information of said wireless base stations comprises inherent identification information of the wireless base stations which are connected in cascade, and wherein said identification information of said wireless base stations is written in respective headers of said position registration packets and sent to said wireless base station accommodating apparatus.

5. A wireless communication system according to claim 1, wherein said wireless base station accommodating apparatus has transfer means for transferring data packets addressed to said mobile terminals to wireless base stations which are identified from contents registered in said position registration table.

6. A wireless base station accommodating apparatus for accommodating a plurality of wireless base stations for performing wireless data communications with mobile terminals which are accommodated respectively thereby, comprising:
detecting means for detecting positions of said mobile terminals; and
a position management table for registering therein identification information of said mobile terminals detected by said detecting means and identification information of said wireless base stations which accommodate said mobile terminals.

7. A wireless base station accommodating apparatus according to claim 6, wherein said detecting means detects positions of said mobile terminals from position registration packets sent from the mobile terminals.

8. A wireless base station accommodating apparatus according to claim 6, wherein the identification information of said wireless base stations comprises the numbers of ports through which said wireless base stations are connected to said wireless base station accommodating apparatus.

9. A wireless base station accommodating apparatus according to claim 7, wherein the identification information of said wireless base stations comprises inherent identification information of the wireless base stations which are connected in cascade, and wherein said identification information of said wireless base stations is written in respective headers of said position registration packets and sent to said wireless base station accommodating apparatus.

10. A wireless base station accommodating apparatus according to claim 6, further comprising:
transfer means for transferring data packets addressed to said mobile terminals to wireless base stations which are identified from contents registered in said position registration table.

11. A method of transferring data packets to mobile terminals in a wireless communication system including a plurality of wireless base stations for performing wireless data communications with mobile terminals which are accommodated respectively thereby, and a wireless base station accommodating apparatus for accommodating said wireless base stations, comprising the steps, performed by said wireless base station accommodating apparatus, of;
detecting positions of said mobile terminals; and
registering therein identification information of said mobile terminals which are detected and identification information of said wireless base stations which accommodate said mobile terminals.

12. A method according to claim 11, wherein said detecting step comprises the step of detecting positions of said mobile terminals from position registration packets sent from the mobile terminals.

13. A method according to claim 11, wherein the identification information of said wireless base stations comprises numbers of ports through which said wireless base stations are connected to said wireless base station accommodating apparatus.

14. A method according to claim 12, wherein the identification information of said wireless base stations comprises inherent identification information of the wireless base stations which are connected in cascade, and wherein said identification information of said wireless base stations is written in respective headers of said position registration packets and sent to said wireless base station accommodating apparatus.

15. A method according to claim 11, further comprises the step, performed by said wireless base station accommodating apparatus, of;
transferring data packets addressed to said mobile terminals to wireless base stations which are identified from contents registered in said position registration table.
